(19) United States
(12) Patent Application Publication
(10) Pub. No.: US 2011/0195334 A1
(43) Pub. Date: Aug. 11, 2011

(54) FUEL CELL STACK INCLUDING INTERCONNECTED FUEL CELL TUBES

(75) Inventors: Aaron T. Crumm, Ann Arbor, MI (US); Timothy LaBreche, Ann Arbor, MI (US)

(73) Assignee: ADAPTIVE MATERIALS, INC., Ann Arbor, MI (US)

(21) Appl. No.: 12/701,767

(22) Filed: Feb. 8, 2010

(51) Int. Cl. H01M 2/08; H01M 8/10

(52) U.S. Cl. 429/479; 429/508; 429/509

(57) ABSTRACT

A solid oxide fuel cell stack includes a first fuel cell tube, a second fuel cell tube, and an interconnect member. The first fuel cell tube further includes an active area having a plurality of electrochemical cells connected in series, a first cathode lead disposed between the plurality of electrochemical cells connected in series and a first fuel cell tube inlet and a first anode lead disposed between the plurality of electrochemical cells connected in series and a first fuel cell tube outlet. The second fuel cell tube includes a second fuel cell tube comprising an active area having a plurality of electrochemical cells connected in series, a second anode lead disposed between a plurality of electrochemical cells connected in series and a first fuel cell tube inlet and a second cathode lead disposed between the plurality of electrochemical cells connected in series and a first fuel cell tube outlet. The interconnect member electrically connecting one of the first anode lead to the second cathode lead and the first cathode lead to the second anode lead.

### FIELD OF THE INVENTION

The present disclosure is related to a fuel cell tubes interconnected within a fuel cell stack.

### BACKGROUND

The statements in this section merely provide background information related to the present disclosure and may not constitute prior art. Fuel cells have been developed for portable power applications to compete with portable generators, batteries, and other energy conversion devices. Fuel cells are advantageous over generators in that fuel cells can operate at higher fuel-to-energy conversion efficiency levels. In particular, a generator's efficiency is limited by an efficiency ceiling defined by the generator's Carnot cycle. Because fuel cells convert a fuel's chemical energy directly to electrical energy, fuel cells can operate at efficiency levels that are much higher than generators at comparable power levels.

Portable fuel cell modules can meet power and energy requirements that are not met by either batteries or other energy conversion devices. For example, high-efficient lithium ion batteries can have more than ten times the weight-to-energy ratio as an energy equivalent fuel cell module inclusive of three days of fuel.

Improvements in performance and cost reduction will enable the large-scale adoption of fuel cells in the commercial marketplace. Areas for fuel cell performance improvement include fuel cell module weight improvements, fuel cell fuel efficiency improvements, and fuel cell durability improvements. Areas of cost improvements include reducing material costs, improving high volume manufacturing efficiency, decreasing fuel consumption, and decreasing operating costs.

The following description and figures sets forth a fuel cell module having improvements in performance and cost, which will progress adoption of fuel cell modules in the commercial applications.

### SUMMARY

A solid oxide fuel cell stack includes a first fuel cell tube, a second fuel cell tube, and an interconnect member. The first fuel cell tube further includes an active area having a plurality of electrochemical cells connected in series, a first cathode lead disposed between the plurality of electrochemical cells connected in series and a first fuel cell tube inlet and a first anode lead disposed between the plurality of electrochemical cells connected in series and a first fuel cell tube outlet. The second fuel cell tube comprises an active area having a plurality of electrochemical cells connected in series, a second anode lead disposed between a plurality of electrochemical cells connected in series and a first fuel cell tube inlet and a second cathode lead disposed between the plurality of electrochemical cells connected in series and a first fuel cell tube outlet. The interconnect member electrically connects one of the first anode lead to the second cathode lead and the first cathode lead to the second anode lead.

### BRIEF DESCRIPTION OF THE DRAWINGS

FIG. 1A depicts a prospective view of a fuel cell module in accordance with an exemplary embodiment of the present disclosure;

FIG. 1B depicts an exploded prospective view of the fuel cell module of FIG. 1A;

FIG. 1C depicts another prospective view of the fuel cell module of FIG. 1A;

FIG. 2 depicts a cross-sectional view of a fuel cell tube of the module of FIG. 1A;

FIG. 3 depicts a cross-sectional view the fuel cell module of FIG. 1A;

FIG. 4 depicts a prospective view of a fuel cell module in accordance with another exemplary embodiment of the present disclosure; and

FIG. 5 depicts a cross sectional view of fuel cells of the fuel cell module of FIG. 4;

It should be understood that the appended drawings are not necessarily to scale, presenting a somewhat simplified representation of various preferred features illustrative of the basic principles of the invention. The specific design features of the electric power generation device will be determined in part by the particular intended application and use environment. Certain features of the illustrated embodiments have been enlarged or distorted relative to others for visualization and clear understanding. In particular, thin features may be thickened, for example, for clarity of illustration. All references to direction and position, unless otherwise indicated, refer to the orientation of the fuel cell module illustrated in the drawings.

### DESCRIPTION

Disclosed is a fuel cell stack having at two types of fuel cell tubes, wherein the first fuel cell tube mirrors the second fuel tube with respect to a plane of symmetry perpendicular to a length (that is, a longitudinal direction of fuel flow) of each fuel cell tube. By segmenting the active areas of each fuel cell tube and by connecting each active area in series, voltage generated by each tube increases proportionally to the number of segments and current generated by each tube decreases proportionally to the number of segments when compared to a fuel cell tube having a similarly-sized, unsegmented active area. For example, when compared to a fuel cell tube having a similarly-sized, unsegmented active area, a fuel cell tube having ten segments connected in series nominally generates approximately ten times the voltage, approximately one tenth the current, and an approximately equivalent amount of power. As used herein, the terms “active area,” refer to an area of the tube comprising an anode and cathode, reacting anode reactants and cathode reactants, respectively, and an ion conducting electrolyte. Further, as used herein the term “tube” refers to any structure generally configured to direct fluid. Although the exemplary fuel cell tube comprises a continuously enclosed substantially circular cross-section, in an alternate embodiment, alternate geometries can be utilized and the cross-section does not have to be fully enclosed. Exemplary alternate geometries include polygonal shapes, for example rectangular shapes, and other ovular shapes.

Although the fuel cell tube having segmented active areas generates approximately equal levels of power to the fuel cell tube having a similarly-sized, unsegmented active area, decreasing a quantity of electrical current transported through each fuel cell tube and through the fuel cell module facilitates several advantageous design characteristics.

For example, decreasing electrical current facilitates utilizing less current conduction capacity to route current from the fuel cell tubes while maintaining equivalent levels of power transfer from the fuel cell tubes. Therefore, by generating less electrical current, fuel cell tubes having segmented active areas connected in series can utilize a less conductive current collection and conduction system for routing electricity away from fuel cell tubes than fuel cell tubes having a similarly-sized, unsegmented active area. “Less conductive current collection and conduction system” as used above, can include a current collection and conduction system with lower amounts of current collecting and conducting material and a current collection and conduction system comprising material with higher resistivity values.

Thus, power can be efficiently transferred from an anode of the fuel cell tubes having segmented active areas connected in series with a current collector that is sized much smaller than a current collector of an unsegmented fuel cell tube generating equivalent amounts of power. In one embodiment, the electrodes of the fuel cell tubes having segmented active areas connected in series comprise a sufficient current conduction capacity to route electrical current from the fuel cell tubes without utilizing a current collector disposed within the inner circumference of the fuel cell tube.

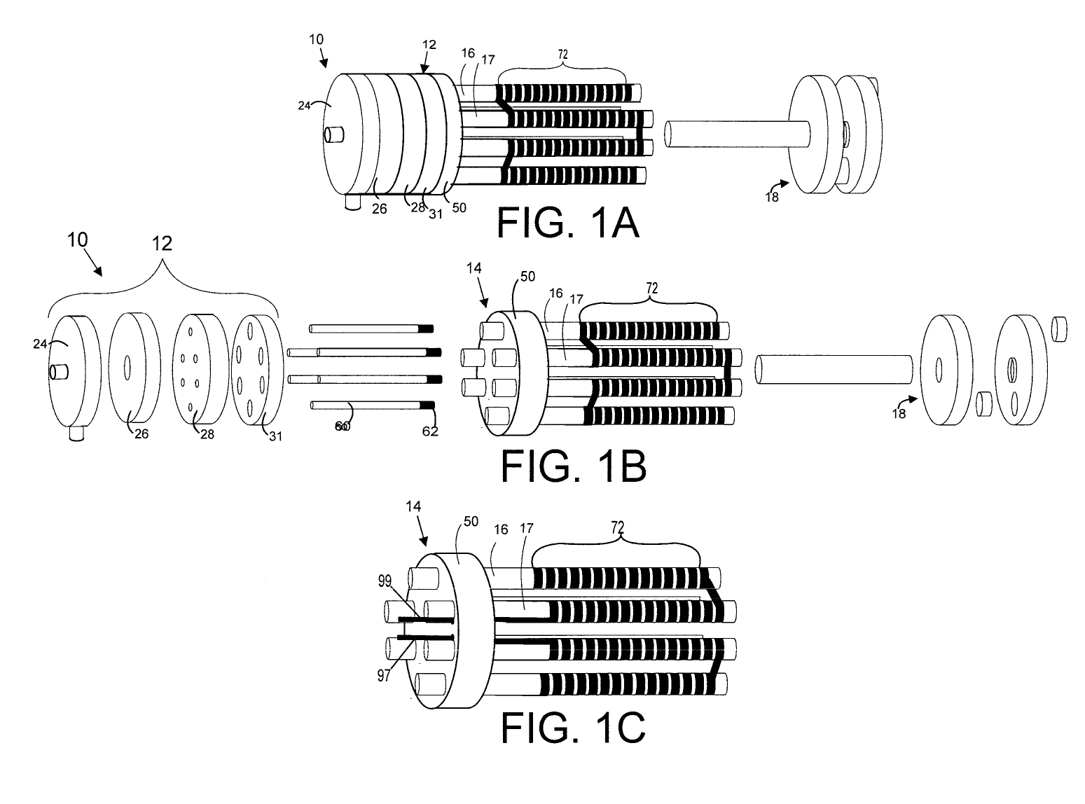

Referring to FIGS. 1A, 1B, 1C, 2, and 3 a fuel cell module 10 includes a fuel cell stack 14, a manifold member 12, and a heat recuperator 18. The fuel cell stack 14 includes a fuel cell tube 16 and a fuel cell tube 17, tube-to-tube interconnect members 229, fuel feed tubes 60 disposed in each of the fuel cell tubes 16, 17, an internal reformer 62 disposed in each of the fuel feed tubes 60, insulating walls 50 defining an insulative chamber 52, a cathode terminal lead 99, and an anode terminal lead 97.

The fuel cell tube 16 and the fuel cell tube 17 mirror one another with respect to a plane of symmetry perpendicular to a length of each fuel cell tube. The fuel cell tube 16 includes a fuel cell tube inlet 80, a fuel cell tube outlet 82, a support potion 202, a gas and electrical barrier portion 207, and a plurality of electrochemical cells 201 electrically connected in series disposed between the fuel cell tube inlet 80 and the fuel cell tube outlet 82. The fuel cell tube 17 includes a fuel cell tube inlet 90, a fuel cell tube outlet 92, a support portion 222 a gas and electrical barrier portion 227, and a plurality of electrochemical cells 221 electrically connected in series disposed between the fuel cell tube inlet 90 and the fuel cell tube outlet 92.

The electrochemical cells 201 of the fuel cell tube 16 are orientated such that a cathode lead 209 is disposed between the plurality of electrochemical cells 201 and the fuel cell tube inlet 80, and such that an anode lead 203 comprises a contact pad 216 disposed between the plurality of electrochemical cells 201 and the fuel cell tube outlet 82. In particular, each electrochemical cell 201 includes a cathode portion 210, a cathode current collector portion 214, an electrolyte portion 206, an anode portion 204, and a cell-to-cell interconnect member 212, wherein the cathode current collector portion 214 of each electrochemical cell 201 extends beyond the electrolyte 206 in a direction toward the fuel cell tube inlet 80, and wherein the anode portion 204 of each electrochemical cell extends beyond the electrolyte portion 206 in a direction toward the fuel cell tube outlet 82. Although the exemplary fuel cell tubes 16 and 17 are depicted as having the cathode current collector 214 or 234 extending beyond the electrolyte 206 or 226, in an alternate embodiment, fuel cell tubes can connect segmented cells in series through a cathode extending beyond the electrolyte instead of or in addition to the cathode current collector. The cell-to-cell interconnect member 212 connects adjacent electrochemical cells by connecting the anode portion 204 of the electrochemical cell to the cathode current collector portion 214 and the cathode portion 210 of the adjacent electrochemical cell.

The electrochemical cells 221 of the fuel cell tube 17 are orientated such that a cathode lead 223 is disposed between the plurality of electrochemical cells 221 and the fuel cell tube outlet 92, and such that the anode lead 213 comprises a contact pad 236 is disposed between the plurality of electrochemical cells 221 and the fuel cell tube inlet 90. In particular, each electrochemical cell 221 includes a cathode portion 220, a cathode current collector portion 234, an electrolyte portion 226, an anode portion 224, and a cell-to-cell interconnect member 232, wherein the cathode current collector portion 234 of each electrochemical cell 221 extends beyond the electrolyte 226 in a direction toward the fuel cell tube outlet 92, and wherein the anode portion 224 of each electrochemical cell 221 extends beyond the electrolyte 226 in a direction toward the fuel cell tube inlet 90. The interconnect member 232 connects adjacent electrochemical cells by connecting the anode portion 224 of the electrochemical cell to the cathode portion 220 of the adjacent electrochemical cell.

Collectively for each fuel cell tube 16, 17 the anode portions 204, 224 are referred to as “anode” herein, the electrolyte portions 206, 226 are referred to as “electrolyte” herein and the cathode portions 210, 220 are referred to as “cathode” herein. Components that make up the fuel cell tube 16 and the fuel cell tube 17 will now be described. However, the components will be described only with reference to the fuel cell tube 16 and it is to be understood that the fuel cell tube 17 can comprise substantially similar materials and can be manufactured by similar processes to the materials and processes described with reference to the fuel cell tube 16.

The support portion 202 can be formed through extrusion processes, pressing processes, casting processes, and like processes for forming ceramic members. For an exemplary thermoplastic extrusion processes see U.S. Pat. No. 6,749,799 to Crumm et al, entitled METHOD FOR PREPARATION OF SOLID STATE ELECTROCHEMICAL DEVICE, the entire contents of which is hereby incorporated by reference, herein.

In an exemplary thermoplastic ceramic extrusion process for forming support portion 70, a compound is prepared from 85.9 weight percent of 8 mole % yttria stabilized zirconia powder, 7.2 weight percent of polyethylene polymer, 5.3 weight percent of acrylate polymer, 1.0 weight percent of stearic acid, and 0.3 weight percent of heavy mineral oil, 0.3 weight percent of polyethylene glycol of a molecular weight of 1000 grams per mole. The microstructure and porosity of the support portion 202 can be tailored for desired gas diffusion rates and for chemical and thermomechanical compatibility with other portions of the fuel cell tube 16 including the electrolyte portion 206 and the barrier portion 207. The exact microstructure and porosity of the support portion 202 can be controlled in several ways, including through modifying the sintering temperature, modifying particle size distribution of the ceramic powder, engineering microstructure by extruding and co-extruding channels, and by the using pore-forming additives, such as carbon particles or similar pore-formers.

The anode portion 204 comprises an electrically and ionically conductive cermet that is chemically stable in a reducing environment. In an exemplary embodiment, the anode portion 204 comprises a conductive metal such as nickel, disposed in a ceramic skeleton, such as yttria-stabilized zirconia.

Exemplary materials for the electrolyte portion 206 and the electron barrier portion 207 includes lanthanum-based materials, zirconium-based materials and cerium-based materials such as lanthanum strontium gallium manganite, yttria-stabilized zirconia and gadolinium doped ceria, and can further include various other dopants and modifiers to affect ion conducting properties. The anode portion 204 and the cathode portion 210 which form phase boundaries (gas module/ion/electron; known as triple points) with the electrolyte portion 206 and are disposed on opposite sides of the electrolyte portions 206 with respect to each other.

The electrolyte portions 206 are disposed both on a surface of the anode portion 204 parallel to the anode portions 204 and abutting the anode portions 204. The section of the electrolyte portion 206 parallel to the anode portion provides an ion conduction pathway and electron insulation between the anode portion 204 and the cathode portions 210. The section of the electrolyte portions 206 abutting the anode portion 204 provides electron insulation between anode portions of separate electrochemical cells 201.

In general, the anode portion 204 and cathode portion 210 are formed of porous materials capable of functioning as an electron and ion conductor and capable of facilitating the appropriate reactions. The porosity of these materials allows dual directional flow of gases (e.g., to admit the fuel or oxidant gases and permit exit of the byproduct gases).

The cathode comprises a conductive material chemically stable in an oxidizing environment. In an exemplary embodiment, the cathode comprises a perovskite material and specifically lanthanum strontium cobalt ferrite (LSCF). In an exemplary embodiment, each of the anode, electrolyte, and cathode are disposed within a range, of about 5-50 micrometers. An intermediate layer 208 may be disposed between the cathode portion 210 and the electrolyte portion 206 to decrease reactivity between material in the cathode portion 210 and material in the electrolyte portion 206. In an exemplary embodiment, the intermediate portion 208 comprises strontium-doped ceria (SDC), and is disposed at a thickness within the range of 1-8 micrometers. In alternate embodiment, the fuel cell tube can comprise a cathode without an intermediate portion, for example, a cathode comprising lanthanum strontium manganite (LSM).

The cell-to-cell interconnection portion 212 electrically connects an anode of a electrochemical cell to a cathode of a separate electrochemical cell such that electrons can be conducted in series between the electrochemical cells. In an exemplary embodiment the interconnection portion comprises platinum. The current collector portion 214 conducts electrons across the cathode portion 210. In an exemplary embodiment, the current collector portion comprises a silver palladium alloy.

Providing the fuel cell stack 14 that includes different types of fuel cell tubes (fuel cell tube 16 and fuel cell tube 17 as described above) facilitates a highly efficient, highly robust and low cost design. For example, the fuel cell stack 14 is desirably low in cost because the fuel cell stack 14 comprises low levels of material that can be utilized for tube-to-tube interconnection and because low levels of material can be utilized to route current from the plurality of cells disposed on each fuel cell tube.

The tube-to-tube interconnect members 229 electrically connects anodes of one style of fuel cell tube 16 or 17 to cathodes of another style of the fuel cell tubes 16 or 17. The anode and cathode terminal leads 99, 97 extend from the active areas 72 within the insulated chamber 52 through the insulative walls 50 to the outside of the insulative chamber 52. Each of the tube-to-tube interconnect members 229 and the anode and cathode terminal leads 99, 97 can comprise material generally compatible with the high temperature environment of the fuel cell stack 14. In an exemplary embodiment, the tube-to-tube interconnect members 229 and the anode and cathode terminal leads 99, 97 comprise silver palladium wires. In alternative embodiment, the interconnect members 229 and the anode and cathode terminal leads 99, 97 can comprise various metals and metal including those comprising palladium, platinum, chromium, and nickel. The tube-to-tube interconnects members 229 of the fuel cell stack 14 enable tube spacing and enables robust manufacturing processes. Further the fuel stack 14 is desirably highly efficient because the fuel stack 14 comprises short tube-to-tube connection paths and because the stack 14 is configured to facilitate high voltage, and low levels of electrical current electrical conduction throughout fuel cell stack 14. Further, low cost mass manufacturing processes can be utilized to manufacturer the fuel cell stack 14.

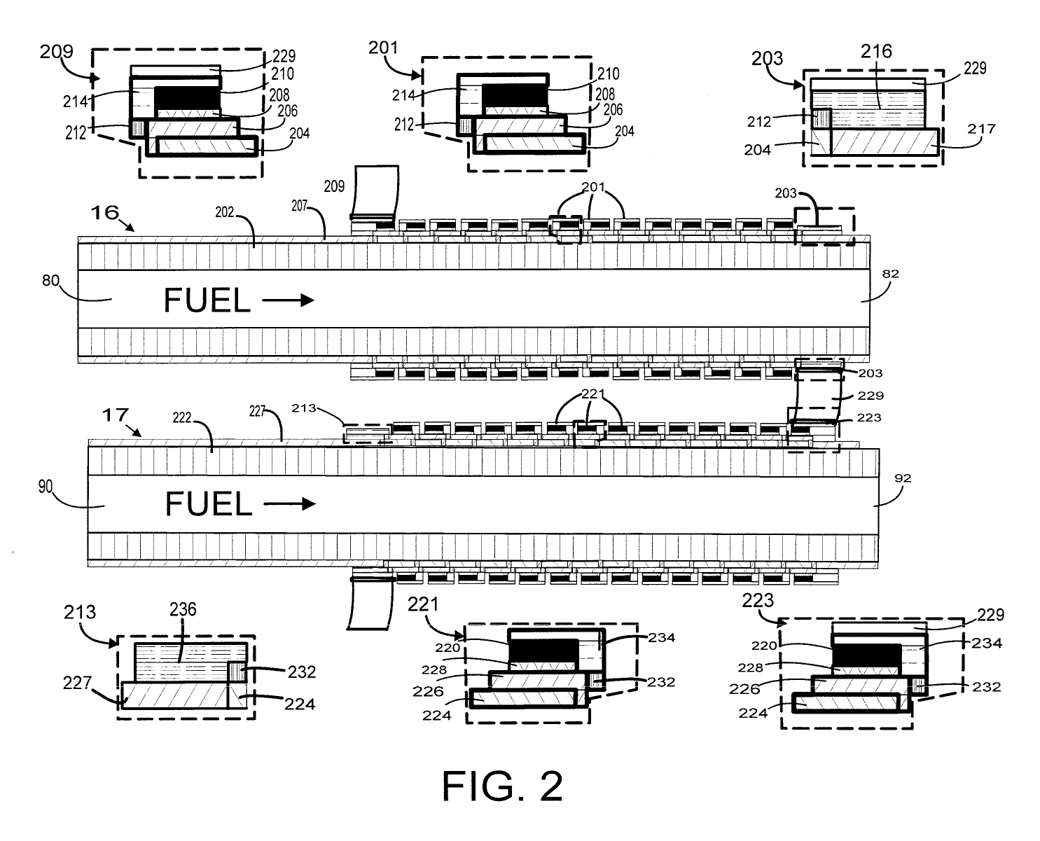

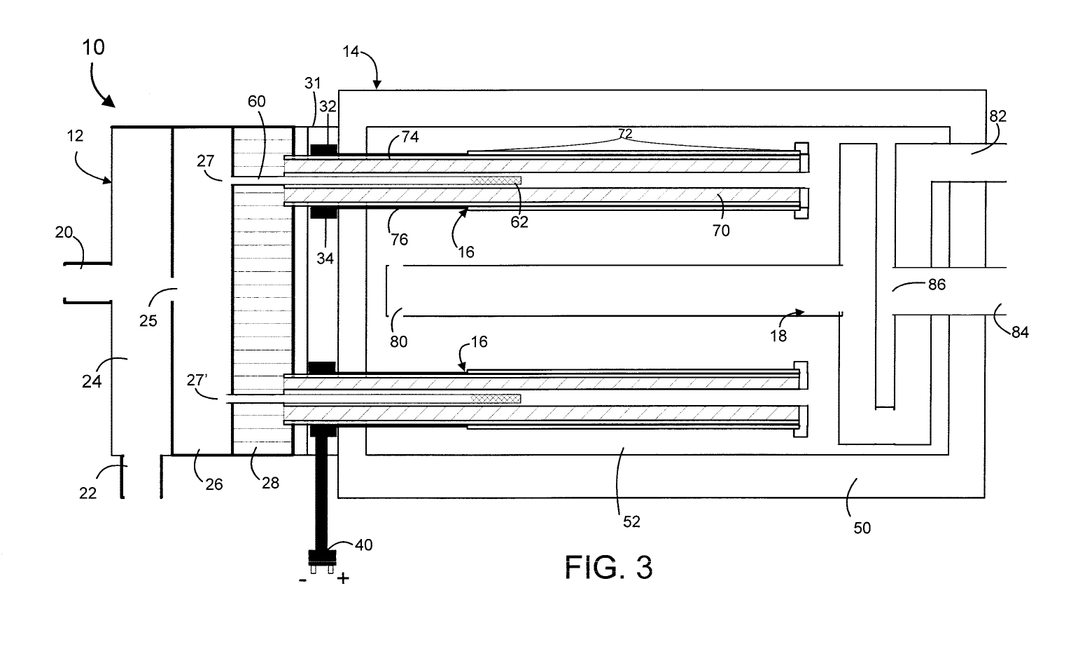

Referring to FIGS. 1A, 1B, and 3, the manifold 12 comprises a mixing portion 24, a distribution portion 26, a base portion 28, and an electrical connector portion 31 having an electrical connector 40 for routing electricity from the fuel cell module 10. The manifold 12 receives air through the air inlet 22 and raw fuel through the fuel inlet 20. The heat recuperator 18 is provided to transfer heat between fuel cell exhaust and incoming cathode air to the insulated chamber 52. The cathode air is routed to cathode portions 210 (FIG. 2) of the fuel cell tubes 16 and is utilized as an electrochemical reactant for reactions at the cathode of the fuel cell tubes 16. The heat recuperator 18 includes an air inlet 82, an air outlet 80, an exhaust inlet 86, and an exhaust outlet 84.

The fuel feed tube 60 extends from the distribution chamber 26 into the insulation chamber 52. The fuel feed tube 60 is disposed in a fuel cell tube 16, wherein the fuel cell tube 16 extends from the base portion 28 into the insulated chamber 52. The insulative body 50 can comprise high-temperature, ceramic-based material, for example, foam, aero-gel, mat-materials, and fibers formed from, for example, alumina, silica, and like materials.

The fuel feed tube 60 comprises a dense ceramic material compatible with the high operating temperatures within the insulated chamber 52, for example, an alumina based material or a zirconia based material.

The reformer 62 comprises a supported metallic catalyst material comprising a metal alloy comprising at least one of platinum, palladium, rhodium, rubidium, iridium, osmium, and the like disposed on a ceramic substrate such as an alumina substrate or a zirconia substrate, wherein the ceramic substrate is disposed within the fuel feed tube 60. In particular, the reformer 62 can be substantially similar to that described in further detail in U.S. Pat. No. 7,547,484 entitled “Solid Oxide Fuel Cell Tube With Internal Fuel Processing”, the entire contents of which is hereby incorporated by reference herein. Fuel can be routed through the reformer 62 such that substantially no unreformed fuel contacts an anode portion 204 of the fuel cell tube 16.

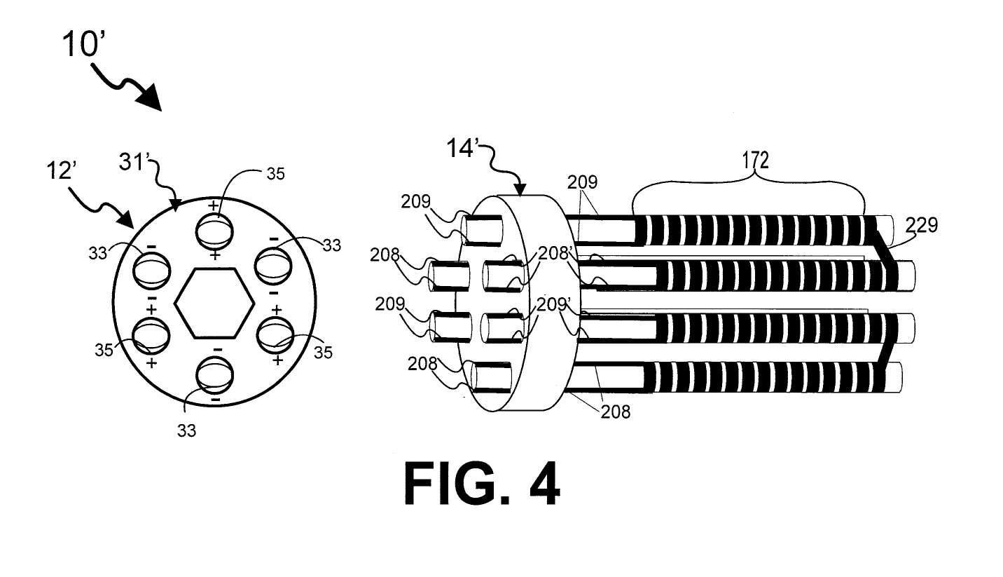

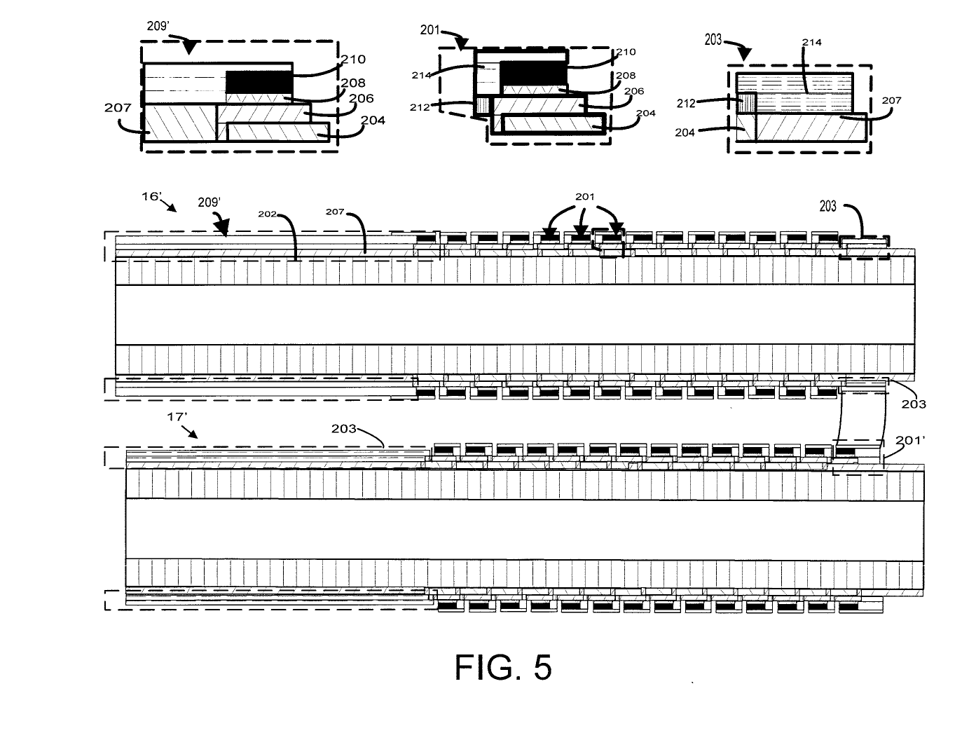

Referring to FIGS. 4 and 5 a fuel cell module 10′ comprising a fuel cell stack 14′ and a manifold member 12′ is shown. The fuel cell stack 14′ is substantially similar to fuel cell stack 14, however, fuel cell stack 14′ includes fuel cell tubes 16′ and fuel cell tubes 17′ in place of the fuel cell tubes 16 and the fuel cell tubes 17. The fuel cell tube 16′ includes a fuel cell tube inlet 80′, a fuel cell tube outlet 82′, the support potion 202, the gas and electron barrier portion 207, and the plurality of electrochemical cells 201 electrically connected in series disposed between the fuel cell tube inlet 80 and the fuel cell tube outlet 82. The fuel cell tube 17′ further includes an anode lead 209′ disposed as a layer on the barrier portion 207 extending from the plurality of electrochemical cell 201 to the fuel cell tube outlet 90′, and the fuel cell tube 17′ further includes the fuel cell tube inlet 90, the fuel cell tube outlet 92, the support portion 222, a barrier portion 227, and a plurality of electrochemical cells 221 electrically connected in series disposed between the fuel cell tube inlet 90 and the fuel cell tube outlet 92.

Each of the anode lead 213′ and the cathode lead 209′ can comprise an electronically conductive material compatible with the high temperature oxidative environment of the fuel cell stack 10′. In an exemplary embodiment, the anode lead 213′ and the cathode lead 209 comprises silver palladium. In alternate embodiments, the anode lead and the cathode lead comprises alloys of silver, palladium, gold, platinum, nickel, chromium, iron, and like materials.

The fuel cell stack comprises an electrical connection portion 31′, which includes a positive electrical connection members 33 and negative electrical connection members 35. In the exemplary embodiment, the electrical connection members 33, 35 comprise spring-loaded electrical contacts adapted to receive each of the fuel cell tubes 16′, 17′, respectively to establish an electrical connection path between the anode and cathode leads 208′, 209′ and the electrical connection member 31′. In alternate embodiments, various other electrical connection members can be utilized to interconnect the fuel cell tubes 16′, 17′ with the electrical connection member 31′. Alternative connection members can include plug-in outlets, wrapped members, coil members, crimped pieces and other electrical interconnections.

The exemplary embodiments shown in the figures and described above illustrate, but do not limit, the claimed invention. It should be understood that there is no intention to limit the invention to the specific form disclosed; rather, the invention is to cover all modifications, alternative constructions, and equivalents falling within the spirit and scope of the invention as defined in the claims. Therefore, the foregoing description should not be construed to limit the scope of the invention.

1. A solid oxide fuel cell stack comprising:
a first fuel cell tube comprising a first fuel cell tube inlet and a first fuel cell tube outlet, the first fuel cell tube comprising an active area having a plurality of electrochemical cells connected in series, a first cathode lead disposed between the plurality of electrochemical cells connected in series and the first fuel cell tube inlet and a first anode lead disposed between the plurality of electrochemical cells connected in series and the first fuel cell tube outlet;
a second fuel cell tube comprising a second fuel cell tube inlet and a second fuel cell tube outlet, the second fuel cell tube comprising an active area having a plurality of electrochemical cells connected in series, a second anode lead disposed between the plurality of electrochemical cells connected in series and the first fuel cell tube inlet and a second cathode lead disposed between the plurality of electrochemical cells connected in series and the first fuel cell tube outlet; and
a tube-to-tube interconnect member electrically connecting one of the first anode lead to the second cathode lead and the first cathode lead to the second anode lead.

2. The solid oxide fuel cell of claim 1, wherein the interconnect member extends between the first fuel cell tube and the second fuel cell tube in a direction substantially perpendicular to a length of the first fuel cell tube.

3. The solid oxide fuel cell of claim 1 further comprising an anode portion, an electrolyte portion and a cathode portion, wherein the anode portion, cathode portion, and electrolyte portion comprise printed patterns.

4. The solid oxide fuel cell of claim 1, wherein the interconnect member comprises at least one member of the group consisting of silver, gold and palladium.

5. The solid oxide fuel cell of claim 1, further comprising a cathode current carrier disposed on the cathode portion of the fuel cell tube.

6. The solid oxide fuel cell of claim 1, wherein at least one of an anode and an anode current collector of each electrochemical cell of the first fuel cell tube outlet extends past the electrolyte toward first fuel cell tube outlet and wherein at least one of an anode and an anode current collector of each electrochemical cell of the second fuel cell tube extends past the electrolyte toward the second fuel cell tube inlet.

7. The solid oxide fuel cell of claim 1, wherein at least one of a cathode and a cathode current collector of each electrochemical cell of the first fuel cell tube outlet extends past the electrolyte toward first fuel cell tube inlet and wherein at least one of a cathode and a cathode current collector of each electrochemical cell of the second fuel cell tube extends past the electrolyte toward the second fuel cell tube outlet.

8. The solid oxide fuel cell module of claim 1, wherein the tube-to-tube interconnect member interconnects fuel cell tubes in a series electrical connection.

9. The solid oxide fuel cell of claim 1, further comprising insulative walls defining an insulative chamber, the first fuel cell tube extending from a first location outside the insulative chamber at the first tube inlet portion to a second location inside the insulative chamber at the first tube outlet portion, wherein the plurality of electrochemical cells connected in series is disposed within the insulative chamber and wherein the lead disposed between the plurality of electrochemical cells connected in series and the first fuel cell tube inlet extends from a portion of the first fuel cell tube inside the insulative chamber to a portion of the fuel cell tube outside the insulative chamber.

10. The solid oxide fuel cell of claim 1 wherein the first anode lead and the first cathode lead are surface deposited leads.

11. The solid oxide fuel cell of claim 1, further comprising an internal fuel reformer dispose inside the fuel cell tube.

12. A solid oxide fuel cell stack comprising:
a first tube having a plurality of electrochemical cells interconnected in a first direction; and
a second tube having a plurality of electrochemical cells interconnected in a second direction, wherein the first fuel cell tube mirrors the second fuel tube with respect to a plane of symmetry perpendicular to a length of the first fuel cell tube.

13. The solid oxide fuel cell of claim 12 wherein the first anode lead and the first cathode lead are screen printed leads.

14. The solid oxide fuel cell of claim 12, further comprising an internal fuel reformer disposed inside the first solid oxide fuel cell tube.

15. The solid oxide fuel cell of claim 12, wherein the interconnect member extends between the first fuel cell tube and the second fuel cell tube in a direction substantially perpendicular to a length of the first fuel cell tube.

16. The solid oxide fuel cell of claim 12 further comprising an anode portion, an electrolyte portion and a cathode portion, wherein the anode portion, cathode portion, and electrolyte portion comprise printed patterns.

17. The solid oxide fuel cell of claim 12, wherein the interconnect member comprises at least one member of the group consisting of silver and palladium.

18. The solid oxide fuel cell of claim 12, wherein at least one of an anode and an anode current collector of each electrochemical cell of the first fuel cell tube extends past the electrolyte toward first fuel cell tube outlet and wherein at least one of an anode and an anode current collector of each electrochemical cell of the second fuel cell tube extends past the electrolyte toward the second fuel cell tube inlet, and wherein at least one of a cathode and a cathode current collector of each electrochemical cell of the first fuel cell tube extends past the electrolyte toward first fuel cell tube inlet and wherein at least one of a cathode and a cathode current collector of each electrochemical cell of the second fuel cell tube extends past the electrolyte toward the second fuel cell tube outlet.

19. The solid oxide fuel cell module of claim 12, wherein the tube-to-tube interconnect member interconnects tubes in a series electrical connection.

20. The solid oxide fuel cell of claim 12, further comprising a cathode current carrier disposed on the cathode portion of the fuel cell tube.
